(19) United States
(12) Patent Application Publication
(10) Pub. No.: US 2014/0212320 A1
(43) Pub. Date: Jul. 31, 2014

(54) LASER IGNITION OF REACTION SYNTHESIS SYSTEMS

(71) Applicant: Colorado School of Mines, Golden, CO (US)

(72) Inventor: Reed Ayers, Golden, CO (US)

(73) Assignee: Colorado School of Mines, Golden, CO (US)

(21) Appl. No.: 14/168,901

(22) Filed: Jan. 30, 2014

Related U.S. Application Data
(60) Provisional application No. 61/758,372, filed on Jan. 30, 2013.

(51) Int. Cl. B23K 31/02

(52) U.S. Cl. CPC B23K 31/02
USPC 420/8; 228/198

(57) ABSTRACT

The present invention provides a process of initiating a self-propagating reaction with a coherent radiation source, which comprises mixing the chemical reactants, and contacting the chemical reactants by the coherent radiation, more specifically, the coherent radiation source may be a laser.

### CROSS-REFERENCE TO RELATED APPLICATIONS

This application claims the benefit of U.S. Provisional Patent Application Ser. No. 61/758,372, filed Jan. 30, 2013, the entire disclosure of which is hereby incorporated herein by reference.

### TECHNICAL FIELD

This invention relates to the use of lasers to initiate self-propagating reactions.

### BACKGROUND OF INVENTION

The production of high performance materials can incur many costly penalties in terms of energy consumption and extended manufacturing time. Considerable research has gone into reducing the energy input and time consumption involved in materials manufacturing. One attractive approach is to form materials using self-sustaining, or self-propagating reactions, wherein the heat of formation of the products drives the reaction to completion, i.e. to the right. Several chemical approaches that utilize self-propagating reactions include combustion synthesis (CS), self propagating high-temperature synthesis (SHS), and rapid solid-state metathesis reactions (SSM). An example of an energetic self-propagating reaction is the SSM reaction between GaI₃ with Li₃N to produce GaN shown in Eq. 1:

GaI₃+Li₃N→GaN Eq. 1.

The driving force of this reaction is ΔHᵣₓₙ of −515 kJ, which is four times as energetic as the elemental reaction of Ga+0.5 N₂→GaN (ΔHᵣₓₙ of −110 kJ). The key aspects of these reactions are that they are self-propagating, and that they require an external energy source to initiate, or ignite the reaction.

SHS, like SSM reactions, is a process that utilizes the exothermic properties found in the synthesis of many compounds to create a self-sustaining reaction. The process takes advantage of the exothermic nature of the reactions and offers users benefits including high purity of product, lower energy and material costs and reduced overall time of manufacturing. SHS products can be tailored with specific amounts of porosity, and because of the reactions unique thermodynamics and kinetics, a number of advantageous intermediate, nonstoichiometric products are possible.

Many different types of materials have been prepared using SHS processes. An example of an SHS reaction is the so-called thermite reaction, wherein a metal and a metal oxide undergo a highly exothermic oxidation/reduction reaction that produces tremendous heat. For example, the reaction between iron oxide and aluminum given in Eq. 2:

Fe₂O₃+2 Al→2 Fe+Al₂O₃ Eq. 2

The highly reactive nature of aluminum drives the reaction to the right by aluminum oxidation and iron reduction. While this reaction will burn brightly and generate much heat, it does not require external oxygen and can, therefore, proceed in locations with limited air flow, or even under water.

An aspect of self-propagating reactions, including SHS, that still remains a challenge, especially in remote locations, is initiation. Even though a self-propagating reaction is exothermic, in order for the reaction to become self-sustaining, sufficient energy must be present during the initiation process for a small portion of the reactants to convert to the desired product phases. Once the reaction is initiated in a local region, an energetic reaction wave proceeds through the remaining mass of reactants. Initiation is typically performed through resistive heating that requires a large power source and is typically not portable.

Thus, what is needed in order to make self-propagating reactions more wide-spread and industrially compatible are portable ignition sources that could be used in locations outside of a laboratory or manufacturing facility. It would be particularly useful to be able to initiate self-propagating reactions to join ends of metal structures, such as pipes, in remote or hard to access locations.

### SUMMARY

Embodiments and configurations of the present invention address these and other needs. More specifically, one aspect of the present invention provides a process of initiating a self-propagating reaction with a coherent radiation source, which comprises preparing the chemical reactants, positioning the coherent radiation source and chemical reactants in such a way as to allow contacting of the chemical reactants by the coherent radiation, and contacting the chemical reactants with coherent radiation, more specifically, the coherent radiation source may be a laser. The wavelength of the laser is variable, and may be varied between 200 and 1,500 nm. The laser can fire in a pulsed fashion, and the pulses may vary between 0.01 to 1.0 seconds. The power of the coherent radiation pulses may vary between 100-2,000 watts. The process of positioning may involve using lenses to focus the radiation, and may involve using mirrors to position the focused radiation in a place that is not directly opposite the laser opening.

### BRIEF DESCRIPTION OF DRAWINGS

FIG. 1 depicts a flow diagram for the reaction synthesis method.

### DETAILED DESCRIPTION

Disclosed herein in one aspect of the present invention is a method to initiate, or ignite, self-propagating reactions using a laser. While these reactions may be known as combustion synthesis (CS), or self-propagating high-temperature synthesis (SHS), rapid solid-state metathesis reactions (SSMR), or any number of other names, the key aspects of these reactions are that they are self-propagating and they require an external energy source to initiate, or ignite the reaction. We disclose a method to initiate the self-propagating reaction with a laser pulse, wherein the laser can be used to provide the energy needed for a combustion reaction to take place. The laser can also be used to preheat the reactant materials in order to provide extra enthalpy needed to overcome the activation energy barrier for combustion that may be present. An additional benefit of using a laser to initiate the process, is that laser ignition offers portability and the opportunity to initiate a reaction in a variety of locations, atmospheres, and environments.

There are a variety of applications possible for this process. The biomedical, welding, construction, fabrication and manufacturing industries all can potentially benefit from high purity, low cost materials that can be generated utilizing laser induced self-propagating reactions.

By “chemical material” it is intended to mean an element, a metal, an alloy, an oxide, a metalloid, or any other collection of elements or compounds that can be assembled, agglomerated, collected, pressed, or put together with other elements, metals, alloys, oxides, metalloids, or any other collection of elements or compounds.

By “coherent radiation” it is intended to mean the emission from one or more devices that emits light amplified stimulated emission of radiation. The emission is electromagnetic radiation and may be in the visible, ultra violet, or infrared portion of the electromagnetic spectrum, or in any combination of portions of the electromagnetic spectrum. The coherent radiation is notable for its high degree of spatial and temporal coherence. As used herein, the terms “coherent radiation”, “laser tight”, and “laser emission” are synonymous.

By “green pellet” it is intended to mean an unreacted agglomeration of chemical reactant materials. This agglomeration may be pressed into a shape or form, or may be in a heap or pile. As used herein, the terms “green pellet”, “reactant materials”, and “chemical reactant(s)” are synonymous.

By “initiation” it is intended to mean starting a reaction or process. As used herein, the terms “initiation” and “ignition” are synonymous.

By “laser” it is intended to mean a device that emits tight amplified stimulated emission of radiation. A laser may emit electromagnetic radiation that is in the visible, ultra violet, or infrared portion of the electromagnetic spectrum. The radiation is notable for its high degree of spatial and temporal coherence. As used herein, the terms “laser” and “coherent radiation source” are synonymous.

By “optical fiber” it is intended to mean a flexible, transparent fiber made of glass (silica) or plastic, which may be only slightly thicker than a human hair. It functions as a waveguide, or light pipe to transmit light between the two ends of the fiber.

By “product phase” it is intended to mean the material produced by a self-propagating reaction. It may be a metal, an alloy, a ceramic, on oxide, or chemical compound. As used herein, the terms “product phase”, “reaction product”, and “product” are synonymous.

By “reactant” it is intended to mean a chemical material that may be an element, a metal, an alloy, an oxide, a metalloid, or any other collection of elements that can be assembled, agglomerated, pressed, or put together with other reactants or chemical materials.

By “reaction” it is intended to mean a chemical reaction that may be between an element, a metal, an alloy, an oxide, a metalloid, or any other collection of elements that can be assembled, agglomerated, pressed, or put together with other chemical materials.

By “self-propagating” it is intended to mean a reaction that is exothermic, that consumes the available reactants, and that proceeds to completion once initiated. As used herein, the terms “self-propagating”, “self-sustaining” and “combustion” are synonymous.

By “tunable” it is intended to mean a laser device that can have the emitted wavelength of the radiation vary over some wavelength range. As used herein, the terms “tunable” and “variable” are synonymous.

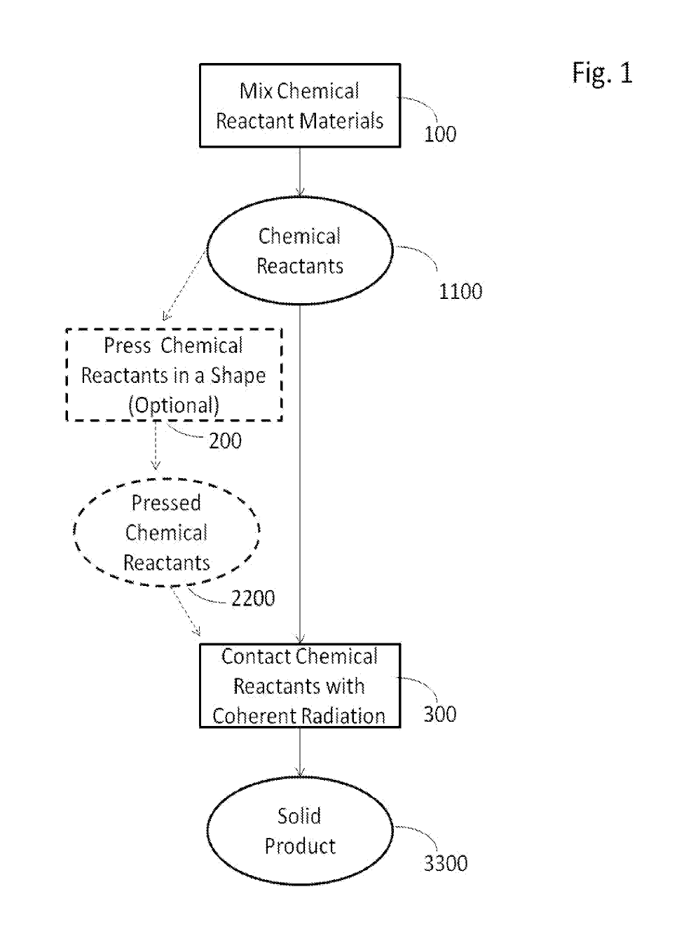

FIG. 1 shows a process flow for one embodiment of the self-propagating reaction. The reactant materials are sourced commercially in powder form in the desired size range and purity. The chemical reactant materials include a first chemical reactant comprising a metal oxide, and a second chemical reactant comprising aluminum (Al). The metal oxide is an oxide of a transition metal selected from the group consisting of scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), ruthenium (Ru), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg). Furthermore, the metal oxide can be an iron oxide selected from the group consisting of iron (II) oxide (FeO), iron (III) oxide (Fe₂O₃), iron (II,III) oxides (Fe₃O₄ and Fe₄O₅), and any combinations thereof.

The chemical reactant materials are then mixed together 100 at specific atomic/weight percent ratios to produce the chemical reactants 1100 that produce the desired product phases upon completion of the reaction. The mixing step may be accomplished by mixing with mechanical vibration, or mixing with mechanical mixing.

Optionally, the chemical reactants can be pressed 200 into a shape 2200 after the mixing Step. Reactant powders can uniaxially pressed into a near net-shape mold in order to obtain a product with the proper shape and density. The unreacted materials, whether pressed into a shape or in the free flowing powder form, can be called “green” materials, Furthermore, the pressing can be performed in a press that is actively cooled, in a press that is actively heated, or in a press that is at ambient conditions.

The self propagating reaction is initiated by contacting the chemical reactants, whether they are free flowing or optionally pressed, with the coherent radiation 300 at an amount of power sufficient to initiate the self-propagating chemical reaction producing a solid product 3300. The self propagating reaction can be performed in a vacuum, in a non-oxygen containing atmosphere, in an oxygen containing atmosphere, or in an atmosphere comprising a gas. The gas atmosphere can be helium, argon, nitrogen, water vapor, oxygen, or carbon dioxide.

Initiating the reaction can involve positioning the coherent radiation source and chemical reactants in such a way as to allow contacting of the chemical reactants by the coherent radiation, and contacting the chemical reactants with coherent radiation. The positioning may involve using lenses to focus the radiation and mirrors to position the focused radiation in a place that is not directly opposite the laser opening. It is also possible to deliver the radiation through a fiber optic to the reactants.

In another embodiment of the invention, the laser light can be transmitted through a fiber optic down a hole to initiate a self-propagating reaction that would repair a metallic object. For example, a hole in a tube on a drill string could be potentially repaired without the necessity of pulling the pipe from the wellbore. The product of the self propagating reaction can be used to seal a hole in a pipe to form a liquid-tight seal. Furthermore, the product of the self propagating reaction can be used join the ends of two adjacent pipes to form a liquid-tight seal.

The mode of laser operation used to initiate the self-propagating reactions may be continuous wave, or pulsed operation. Furthermore, the laser may be gas laser, a chemical laser, an excimer laser, a solid state laser, a fiber laser, a photonic crystal laser, a semiconductor laser, a dye laser, a free electron laser, or a bio laser. The laser may be tunable, as it is when the wavelength of the laser is variable, wherein the wavelength may be varied between about 200 and about 1,500 nm. The laser can fire in a pulsed fashion, wherein the pulses may vary between about 0.01 to about 1.0 seconds. Furthermore, the power of the coherent radiation pulses may be varied between about 100 to about 2,000 watts.

In another embodiment, the reactants may be formed between two objects in such a way that the effect of the self-propagating reaction is to join together the two objects. The objects can be metals, alloys, ceramics, oxides, or other materials. One example, which in no way limits other potential applications, that illustrates the advantages of laser-initiated, self-propagating reactions is repairing remote pipelines. In this case, a laser could be used to initiate a self-propagating reaction such as described in Eq. 1 that could be used to produce iron to join the ends of pipes at a remote location, such as a drill on a production string used in an oil and gas operation.

Experiments have been performed to demonstrate the initiation of self-propagating reactions with a laser.

### Example 1

In some instances, the unreacted green materials are placed into a furnace and heated to their respective ignition temperatures which are dependent on the reactant materials. A fiber-optically coupled laser diode is positioned outside the furnace such that the laser can optimally interact with the preheated green pellet. The laser will fire a 0.3-0.8 second pulse at a power in the range of 200-800 W and a central wavelength between 800-1200 nm depending on absorbance and heat transfer properties of the reactant materials. In addition, the laser can also be potentially used to preheat the green pellet prior to ignition of the material.

This process has many commercial applications. Any manufacturing process that currently uses familiar processing techniques such as casting and forging may benefit from laser-ignited SHS. Initial applications for this process appear to be focused in the oil and gas industries, as well as engineering biomaterials, explosives and potential military/defense applications. This process can be used in mining operations where a thermite reaction is utilized. Furthermore, this process can be used in welding applications where the self-propagating nature of the reactions can be useful under water, in a vacuum, joining pipelines, and in high throughput operations by welding copper, lead, iron, or other metal based pipes.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described hereinabove are further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A process to initiate a self-propagating chemical reaction between at east two chemical reactants with a coherent radiation source, comprising:
mixing the chemical reactants, and
contacting the chemical reactants with the coherent radiation at an amount of power sufficient to initiate the self-propagating chemical reaction.

2. The process of claim 1, wherein the coherent radiation source is a laser.

3. The laser of claim 2, wherein the wavelength of the laser is between about 200 and about 1,500 nm.

4. The laser of claim 2, wherein the laser fires in a pulsed fashion, and wherein t le pulses vary between 0.01 to 1.0 seconds.

5. The laser of claim 2, wherein the power of the coherent radiation pulses may be varied between 100-2,000 watts.

6. The process of claim 1 wherein the contacting comprises using lenses to focus the radiation, and using mirrors to position the focused radiation in a place that is not directly opposite the laser opening.

7. The process of claim 1, wherein a first chemical reactant comprises a metal oxide and a second chemical reactant comprises aluminum (Al).

8. The process of claim 7, wherein the metal oxide is an oxide of a transition metal selected. from the group consisting of scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), ruthenium (Ru), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg).

9. The process of claim 7, wherein the metal oxide is an iron oxide selected from the group consisting of iron (II) oxide (FeO), iron (III) oxide (Fe₂O₃), iron (II,III) oxides (Fe₃O₄ and Fe₄O₅), and any combinations thereof.

10. The process of claim 1, wherein the mixing is accomplished by:
mixing with mechanical vibration; or
mixing with mechanical agitation.

11. The process of claim 1, further comprising pressing the chemical reactants into a shape after the mixing.

12. The process of claim 11, wherein the pressing is performed in a press that is actively cooled, in a press that is actively heated, or in a press that is at ambient conditions.

13. The process of claim 1, wherein the self propagating reaction is performed in air, in a vacuum, in a non-oxygen containing atmosphere, in an oxygen containing atmosphere; or in an atmosphere comprising a gas, wherein the gas is helium, argon, nitrogen, water vapor, oxygen, or carbon dioxide.

14. A solid product of the self-propagating chemical reaction produced by the process of claim 1.

15. The product of claim 14, wherein the product is used to join the ends of two adjacent pipes to form a liquid-tight seal.

16. The product of claim 14, wherein the product is used to seal a hole in a pipe to form a liquid-tight seal.
